(19) United States
(12) Patent Application Publication
(10) Pub. No.: US 2026/0332426 A1
(43) Pub. Date: Oct. 22, 2026

(54) BLOCK PRODUCTION

(71) Applicant: nChain Licensing AG, Zug (CH)

(72) Inventor: Craig Steven WRIGHT

(21) Appl. No.: 19/168,300

(22) PCT Filed: Feb. 29, 2024
(86) PCT No.: PCT/EP2024/055231

§ 371 Date: Sep. 23, 2025

(30) Foreign Application Priority Data
Mar. 27, 2023 (GB) 2304433.2

(51) Int. Cl. H04L 9/32; H04L 9/00

(52) U.S. Cl. CPC H04L 9/3236; H04L 9/50; H04L 2209/56

(57) ABSTRACT

A method performed by a node in a blockchain network, the method comprising: determining if a number of transactions in a set of validated transactions is above a first threshold; when the number of transactions in the set of validated transactions is above the first threshold, performing computations to include the set of validated transactions in a blockchain.

### CROSS REFERENCE TO RELATED APPLICATIONS

This application is the U.S. National Stage of International Application No. PCT/EP2024/055231 filed on Feb. 29, 2024, which claims the benefit of United Kingdom Patent Application No. 2304433.2, filed on Mar. 27, 2023, the contents of which are all incorporated herein by reference in their entireties.

### TECHNICAL FIELD

The present disclosure relates block production in a blockchain network.

### BACKGROUND

Proof-of-Work (PoW) based blockchain technology has been misunderstood as being energy inefficient. In fact, as it scales, it will become more and more energy efficient. As the energy used in producing a block is independent of the number of transactions included in that block, a block with 1 transaction requires the same energy as a block with 1 billion transactions. That is, the more transactions in a block, the more energy efficiency is provided. A few studies show that the energy used in the traditional banking systems that involve ATMs, global branches, as well as printing, minting and transporting physical money, is more than what Bitcoin has consumed. In a future, where Bitcoin as a scalable infrastructure that supports all types of value exchange including information or data exchange globally, the energy consumption will be easily justified.

### SUMMARY

According to one aspect disclosed herein, there is provided a method performed by a node in a blockchain network, the method comprising: determining if a number of transactions in a set of validated transactions is above a first threshold; when the number of transactions in the set of validated transactions is above the first threshold, hashing the set of validated transactions.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of some node software for processing transactions,

FIG. 4 shows a graph for an example hashing strategy; and

FIG. 5 shows a further graph for the example hashing strategy of FIG. 4.

### DETAILED DESCRIPTION OF EMBODIMENTS

### 1. Mining Strategies

According to some examples, energy efficiency of a PoW blockchain further by adopting a mining strategy. The strategy is to increase the hash rate according to the number of transactions or the amount of transaction fees in mempool, and then restart the process as soon as a block is found. A mempool may be considered to comprise a set of validated transactions. As the process is being repeated block by block, the hashing rate varies. In some examples, the hashing rate varies like a sawtooth, providing a sawtooth mining strategy. In some examples, the hashing rate varies according to a start-stop function.

In addition to the gain in energy efficiency, a sawtooth mining strategy and a start-stop mining strategy also allow prolongation of battery usage and the lifespan of hashing hardware. The strategies also save energy used in cooling the hardware during the hashing process.

Most mining businesses adopt a mining pool approach to processing Bitcoin transactions and publishing blocks. A mining pool generally consists of a pool master and many hashing units, potentially distributed globally, or in large hashing farms. The pool master is mainly responsible for constructing block candidates and passing on partial block headers to hashing units to find a good nonce. A reasonably big mining pool would exhaust all possible nonces in less than a minute. When a new block template is constructed, the pool master will naturally include all recently validated transactions in addition to the transaction in the previous block candidate. As a result, the longer it takes to find a block, the more transactions and the higher the transaction fees a node can get in that block. According to some examples, mining starts only when the number of transactions or the transaction fees are high enough to gain energy. According to some examples, energy efficiency is measured by energy consumption per transaction.

The method of the strategies described herein may be performed by a node in a blockchain network. The node may comprise a hashing node. According to some examples, computations for adding a set of validated transactions are performed when a number of transactions in the set of validated transactions is above a first threshold. The computations may include hashing data depending on a set of validated transactions or any other suitable computations. In some examples the data may comprise a block header.

### 1A. Start-Stop Strategy (Step Function)

Assume the following parameters:
Let Nₕₐₛₕ be the expected number of hashes to find a block for a given difficulty. This is from the perspective of the entire network.
Let rₜₓ, r_{fee} be the rate of increase in number of transactions in mempool and the rate of increase in transaction fees from those transactions, respectively.
Let Hᵢ be the hash rate of the node Mᵢ, which is normalised as a percentage of the network hash rate, which is estimated as Nₕₐₛₕ/600. (We assume in this example that the expected block interval is 600 seconds, and the difficulty reflects that; in other examples, the expected block interval may differ) That is, Mᵢ can perform

$${H}_{{‵}^{} i} \frac{{N}_{h a s h}}{600}$$

hashes per second.

Using these parameters, it can be shown that the start-stop strategy allows mining to be more energy efficient as follows.

Let t be the time (seconds after T=0) when Nₕₐₛₕ hashes are done by the network. When it is determined that a number of transactions in a set of validated transaction is above a threshold, the set of validated transactions (the transactions in the mempool) can be hashed.

If every node starts to mine at T=0, then the expected total energy consumption is simply Nₕₐₛₕ units of energy, and we expect a block to contain 600rₜₓ transactions and 600r_{fee} in fees.

If node Mᵢ starts to mine at T=tᵢ for each i and stops at T=t when the network has done in total Nₕₐₛₕ hashes, then we have:

$${\sum }_{i} ( t - {t}_{i} ) \cdot {H}_{i} \frac{{N}_{h a s h}}{600} = {N}_{h a s h} .$$

where t−tᵢ is the number of seconds the node Mᵢ has spent in hashing, and

$${H}_{i} \frac{{N}_{h a s h}}{600}$$

is the number of hashes Mᵢ can perform per second. This implies:

$${\sum }_{i} ( t - {t}_{i} ) {H}_{i} = 600 ,$$

where ΣᵢHᵢ=1. Therefore

$$t = 600 + {\sum }_{i} {t}_{i} {H}_{i} .$$

By the definition of t, we know that the network has spent a total of Nₕₐₛₕ units of energy and is expected to produce a block with tr_{fee} rewards and trₜₓ transactions.

Note that t>600 when tᵢ≠0 for some i. More precisely, ΣᵢtᵢHᵢ is the extra factor that gives more efficiency for using the same amount of energy.

As it takes longer than 10 minutes to mine a block, the difficulty will be slightly reduced in the next difficulty adjustment. As a result, the network hash rate will be more than what the new difficulty suggests. By adopting a sawtooth mining strategy as discussed below (starting at tᵢ≠0) or a start-stop strategy (starting at tᵢ≠0), the expected time to find a block will reach an equilibrium around 10 minutes. That is, the efficiency gain from the sawtooth mining strategy will not be discounted by the difficulty adjustment algorithm.

### 1B. Sawtooth Strategy

The strategy above can be refined by investing an amount of computation power (e.g., hash power) that depends on (e.g., is proportional to) the number of transactions or amount of transaction fees in mempool (i.e. in a validated set of transactions).

Given the hash rate Hᵢ that node Mᵢ has, node Mᵢ can increase the hash rate from a minimum percentage hₘᵢₙ % of Hᵢ as the number of transactions increases in mempool. The increase can be exponential, linear, or logarithmic based on the number of transactions in mempool or transaction fees in mempool.

As an example, the formula below gives the percentage of Hᵢ, denoted by h, to be utilised based on the number of transactions, denoted by x, in mempool. It is parametrised by a linear utilisation factor α, minimum number of transactions for starting to mine, denoted by a threshold value nₜₓ₋ₘᵢₙ, and a minimal percentage of available hash rate to start with, denoted by hₘᵢₙ.

$$h = \{ \begin{matrix}0 , & x < {n}_{tx - min} \\ α ( x - {n}_{tx - min} ) + {h}_{min} , & x \geq {n}_{tx - min} \\ 1 , & x > {n}_{tx - max}\end{matrix}$$

This is a generic formula for a linear dependency on number of transactions, and α is the gradient of the sawtooth. An example with fixed parameters is given in section 1e.

To understand the energy efficiency gained from sawtooth mining strategy, the number of transactions per unit energy can be considered.

Let t be the time (seconds after T=0) when Nₕₐₛₕ hashes are done by the network. Assume that a new block candidate is created every second. That is, based on the number of transactions in the block candidate, the pool master computes the corresponding proportion of hash units they send the partial block header to. Effectively, the hash rate is updated every second. We use hᵢⱼ to denote the percentage of the hash rate

$${H}_{i} \frac{{N}_{h a s h}}{600}$$

that Mᵢ utilises at j-th second.

Therefore, we have:

$${\sum }_{i} ( {\sum }_{j = 1 , … , t} \frac{{h}_{ij} {H}_{i} {N}_{h a s h}}{600} ) = {N}_{h a s h} .$$

$${\sum }_{i} ( {\sum }_{j = 1 , … , t} {h}_{ij} ) {H}_{i} = 600.$$

hᵢⱼ<1 for some i, j, and 0≤hᵢⱼ≤1 for all i, j. This implies that t>E_{j=1, . . . ,t} hᵢⱼ.

Therefore, we have

$${\sum }_{i} t {H}_{i} > {\sum }_{i} ( {\sum }_{j = 1 , … , t} {h}_{ij} ) {H}_{i} = 600 .$$

As ΣᵢHᵢ=1, we have t>600.

This implies that the expected energy consumption to produce a block that contains trₜₓ with a sawtooth mining strategy is the same as to produce a block that contains 600rₜₓ transactions by the current approach (full hash rate at all times). Since t>600, the sawtooth mining strategy is more energy efficient.

According to some examples, there the set of validated transaction are hashed when the number of transactions in a set of validated transactions is above a first threshold nₜₓ₋ₘᵢₙ. In some examples, the hashing rate increases linearly, exponentially or logarithmically. According to some examples, when the set of transactions includes a number of transaction at a maximum threshold, the hashing node hashes at a maximum hashing rate.

In some examples, the hashing rate may be zero until a first threshold value. Between a first threshold value and a second threshold value, the hashing rate may be a first value. Between a second threshold value and a third threshold value, the hashing rate may be a second value higher than the first value. As such, the hashing rate may depend on a step function based on the number of transaction in mempool. This step function may have nay number of steps between a hashing rate of zero and the maximum hashing rate.

### 1C. Sawtooth & Start-Stop Mining Strategies and Renewable Energy

The sawtooth and start-stop mining strategies discussed above allow nodes to stop hashing or reduce energy consumption periodically. This allows the use of green energy more efficiently. For example, the pause in hashing allows some time for the batteries to be charged. The batteries may not get fully charged before used again for hashing. However, when renewable energy such as seasonal water flows has limited-time supply, sawtooth mining strategy can allow nodes to make the most of the supply. For example, the time a node can make use of the energy from a seasonal river can be prolonged. Moreover, battery-based energy supply implies that hashing farm can be built at remote locations where national grid or grid in general is not available. This includes remote areas in desserts where solar power is in excess during the day and not available in the night. The sawtooth mining strategy can, for example, allow the hashing operation to be energy efficient enough to survive the night on the batteries in remote areas.

### 1D. Sawtooth & Start-Stop Mining Strategies and Asics

Application-Specific-Integrated-Chips (ASICs) are high performing chips, and can get heated up quickly. Fans and other cooling mechanisms can consume large amount of energy trying to keep the chips cool enough to do hashing. Sawtooth and start-stop mining strategies discussed above can help in two ways.
1. If all ASICs are turned on at once, the power surge is likely to be so high that will cause circuit breaks. Sawtooth mining strategy allows nodes to turn on ASICs at different time intervals. In addition to the gain in energy efficiency, it also provides a safter way to operate ASICs.
2. ASICs cam the cooling problem. Sawtooth mining strategy allows nodes to turn off ASICs for a brief moment at every block interval. Although the down time might be short, with the help of a cooling system, the chips can be cooled down quickly and ready to be fired up again. This can not only save energy consumption of the cooling system, but also prolong the life of ASICs.
   1E. Sawtooth Mining Strategy with Fixed Parameters

Given the hash rate Hᵢ that node Mᵢ has, they can increase the hash rate from a minimum percentage hₘᵢₙ % of Hᵢ as the number of transactions increases in mempool. An example, the formula below gives the percentage of Hᵢ, denoted by h, to be utilised based on the number of transactions, denoted by x, in mempool. It is parametrised by an utilisation factor α, minimum number of transactions for starting to mine, denoted by nₜₓ₋ₘᵢₙ, and a minimal percentage of available hash rate to start with, denoted by hₘᵢₙ.

$$h = \{ \begin{matrix}0 , & x < {n}_{tx - min} \\ α ( x - {n}_{tx - min} ) + {h}_{min} , & x \geq {n}_{tx - min} \\ 1 , & x > {n}_{tx - max}\end{matrix}$$

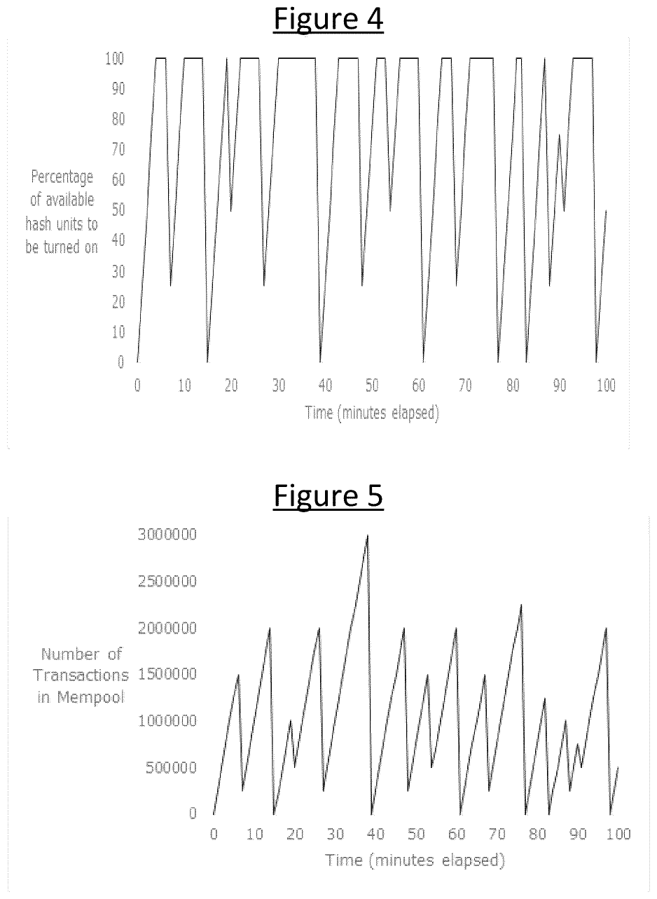

Taking α=0.0001, nₜₓ₋ₘᵢₙ=100,000, hₘᵢₙ=10, and an incoming transaction rate at 250,000 transactions per minute, an example plot is shown in FIG. 4 for variations in percentage of available hash units participating hashing at every minute based on the formula given above. FIG. 5 also shows a number of transactions in mempool based on the variations in a number of transaction in mempool against the time in minutes.

The raw example data for the parameters given in the example above are shown in Table 1.

TABLE 1
Raw data for examples of FIGS. 4 and 5

| nₜₓ₋ₘᵢₙ | Alpha (α) | x | h | Time (minutes) |
|---|---|---|---|---|
| 100000 | 0.0001 | 0 | 0 | 0 |
| 100000 | 0.0001 | 250000 | 25 | 1 |
| 100000 | 0.0001 | 500000 | 50 | 2 |
| 100000 | 0.0001 | 750000 | 75 | 3 |
| 100000 | 0.0001 | 1000000 | 100 | 4 |
| 100000 | 0.0001 | 1250000 | 100 | 5 |
| 100000 | 0.0001 | 1500000 | 100 | 6 |
| 100000 | 0.0001 | 250000 | 25 | 7 |
| 100000 | 0.0001 | 500000 | 50 | 8 |
| 100000 | 0.0001 | 750000 | 75 | 9 |
| 100000 | 0.0001 | 1000000 | 100 | 10 |
| 100000 | 0.0001 | 1250000 | 100 | 11 |
| 100000 | 0.0001 | 1500000 | 100 | 12 |
| 100000 | 0.0001 | 1750000 | 100 | 13 |
| 100000 | 0.0001 | 2000000 | 100 | 14 |
| 100000 | 0.0001 | 0 | 0 | 15 |
| 100000 | 0.0001 | 250000 | 25 | 16 |
| 100000 | 0.0001 | 500000 | 50 | 17 |
| 100000 | 0.0001 | 750000 | 75 | 18 |
| 100000 | 0.0001 | 1000000 | 100 | 19 |
| 100000 | 0.0001 | 500000 | 50 | 20 |
| 100000 | 0.0001 | 750000 | 75 | 21 |
| 100000 | 0.0001 | 1000000 | 100 | 22 |
| 100000 | 0.0001 | 1250000 | 100 | 23 |
| 100000 | 0.0001 | 1500000 | 100 | 24 |
| 100000 | 0.0001 | 1750000 | 100 | 25 |
| 100000 | 0.0001 | 2000000 | 100 | 26 |
| 100000 | 0.0001 | 250000 | 25 | 27 |
| 100000 | 0.0001 | 500000 | 50 | 28 |
| 100000 | 0.0001 | 750000 | 75 | 29 |
| 100000 | 0.0001 | 1000000 | 100 | 30 |
| 100000 | 0.0001 | 1250000 | 100 | 31 |
| 100000 | 0.0001 | 1500000 | 100 | 32 |
| 100000 | 0.0001 | 1750000 | 100 | 33 |
| 100000 | 0.0001 | 2000000 | 100 | 34 |
| 100000 | 0.0001 | 2250000 | 100 | 35 |
| 100000 | 0.0001 | 2500000 | 100 | 36 |
| 100000 | 0.0001 | 2750000 | 100 | 37 |
| 100000 | 0.0001 | 3000000 | 100 | 38 |
| 100000 | 0.0001 | 0 | 0 | 39 |
| 100000 | 0.0001 | 250000 | 25 | 40 |
| 100000 | 0.0001 | 500000 | 50 | 41 |
| 100000 | 0.0001 | 750000 | 75 | 42 |
| 100000 | 0.0001 | 1000000 | 100 | 43 |
| 100000 | 0.0001 | 1250000 | 100 | 44 |
| 100000 | 0.0001 | 1500000 | 100 | 45 |
| 100000 | 0.0001 | 1750000 | 100 | 46 |
| 100000 | 0.0001 | 2000000 | 100 | 47 |
| 100000 | 0.0001 | 250000 | 25 | 48 |
| 100000 | 0.0001 | 500000 | 50 | 49 |
| 100000 | 0.0001 | 750000 | 75 | 50 |
| 100000 | 0.0001 | 1000000 | 100 | 51 |
| 100000 | 0.0001 | 1250000 | 100 | 52 |
| 100000 | 0.0001 | 1500000 | 100 | 53 |
| 100000 | 0.0001 | 500000 | 50 | 54 |
| 100000 | 0.0001 | 750000 | 75 | 55 |
| 100000 | 0.0001 | 1000000 | 100 | 56 |
| 100000 | 0.0001 | 1250000 | 100 | 57 |
| 100000 | 0.0001 | 1500000 | 100 | 58 |
| 100000 | 0.0001 | 1750000 | 100 | 59 |
| 100000 | 0.0001 | 2000000 | 100 | 60 |
| 100000 | 0.0001 | 0 | 0 | 61 |
| 100000 | 0.0001 | 250000 | 25 | 62 |
| 100000 | 0.0001 | 500000 | 50 | 63 |
| 100000 | 0.0001 | 750000 | 75 | 64 |
| 100000 | 0.0001 | 1000000 | 100 | 65 |
| 100000 | 0.0001 | 1250000 | 100 | 66 |
| 100000 | 0.0001 | 1500000 | 100 | 67 |
| 100000 | 0.0001 | 250000 | 25 | 68 |
| 100000 | 0.0001 | 500000 | 50 | 69 |
| 100000 | 0.0001 | 750000 | 75 | 70 |
| 100000 | 0.0001 | 1000000 | 100 | 71 |
| 100000 | 0.0001 | 1250000 | 100 | 72 |
| 100000 | 0.0001 | 1500000 | 100 | 73 |
| 100000 | 0.0001 | 1750000 | 100 | 74 |
| 100000 | 0.0001 | 2000000 | 100 | 75 |
| 100000 | 0.0001 | 2250000 | 100 | 76 |
| 100000 | 0.0001 | 0 | 0 | 77 |
| 100000 | 0.0001 | 250000 | 25 | 78 |
| 100000 | 0.0001 | 500000 | 50 | 79 |
| 100000 | 0.0001 | 750000 | 75 | 80 |
| 100000 | 0.0001 | 1000000 | 100 | 81 |
| 100000 | 0.0001 | 1250000 | 100 | 82 |
| 100000 | 0.0001 | 0 | 0 | 83 |
| 100000 | 0.0001 | 250000 | 25 | 84 |
| 100000 | 0.0001 | 500000 | 50 | 85 |
| 100000 | 0.0001 | 750000 | 75 | 86 |
| 100000 | 0.0001 | 1000000 | 100 | 87 |
| 100000 | 0.0001 | 250000 | 25 | 88 |
| 100000 | 0.0001 | 500000 | 50 | 89 |
| 100000 | 0.0001 | 750000 | 75 | 90 |
| 100000 | 0.0001 | 500000 | 50 | 91 |
| 100000 | 0.0001 | 750000 | 75 | 92 |
| 100000 | 0.0001 | 1000000 | 100 | 93 |
| 100000 | 0.0001 | 1250000 | 100 | 94 |
| 100000 | 0.0001 | 1500000 | 100 | 95 |
| 100000 | 0.0001 | 1750000 | 100 | 96 |
| 100000 | 0.0001 | 2000000 | 100 | 97 |
| 100000 | 0.0001 | 0 | 0 | 98 |
| 100000 | 0.0001 | 250000 | 25 | 99 |
| 100000 | 0.0001 | 500000 | 50 | 100 |

### 2. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

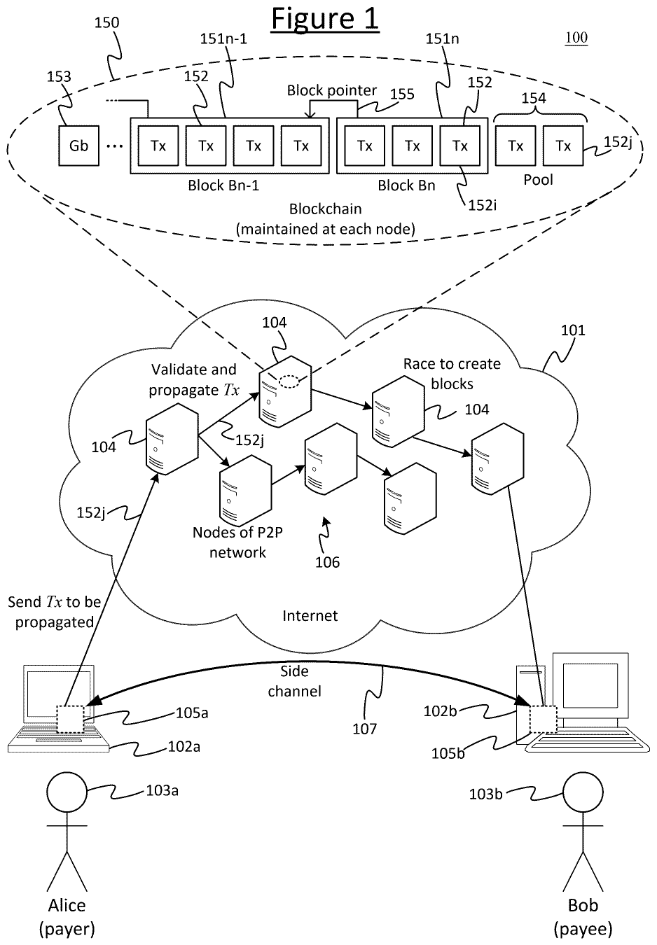

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 3. UTXO-Based Model

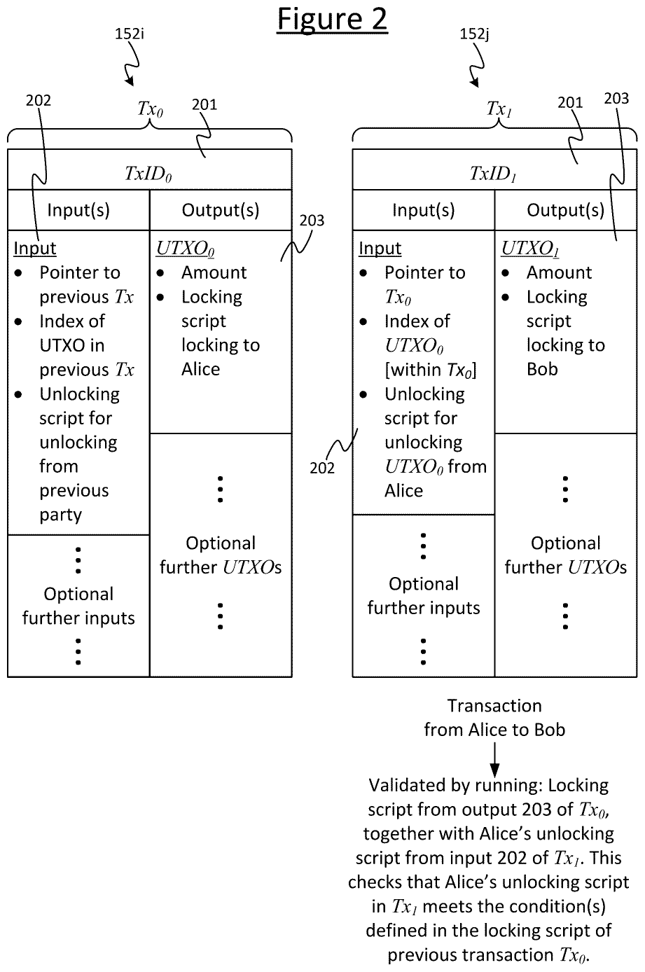

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_. . .” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 4. Node Software

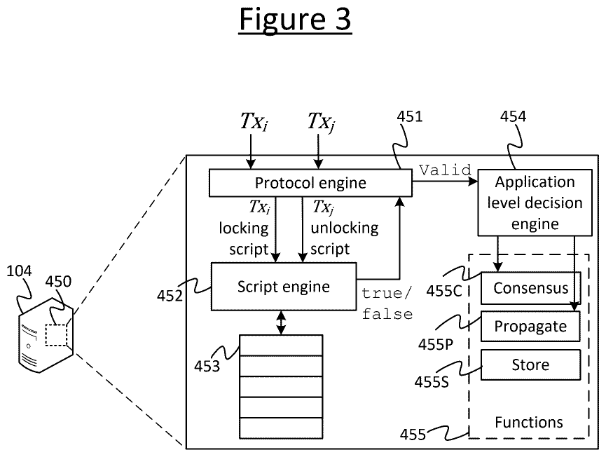

FIG. 3 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains one or more of: a consensus module 455C (for example, proof-of-work), a propagation module 455P and a storage module 455S (for example, a database). The consensus module 455C may contain a validation module (not shown) configured to validate transactions according to the blockchain protocol. The validation module may instead be separate from the consensus module 455C. One or more of the modules may operate in parallel. A node 104 may contain additional modules. The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Tx to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 5. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1: A method performed by a node in a blockchain network, the method comprising: determining if a number of transactions in a set of validated transactions is above a first threshold; when the number of transactions in the set of validated transactions is above the first threshold, performing computation to include the set of validated transactions in a blockchain.

Statement 2: A method according to Statement 1, wherein performing computations to include the set of validated transactions in a blockchain comprises hashing of the set of validated transaction at a hash rate, the hash rate based on the number of transactions in the set of validated transactions.

Statement 3: A method according to Statement 2, wherein the hash rate increases linearly based on the number of transactions in the set of validated transactions.

Statement 4: A method according to Statement 2, wherein the hash rate increases non-linearly based on the number of transactions in the set of validated transactions.

Statement 5: A method according to Statement 2, wherein the hash rate has a first value between the first threshold and a second threshold, and wherein the hash rate has a second value between the second threshold and a third threshold, wherein the second value is greater than the first value.

Statement 6: A method according to Statement 5, wherein the hash rate has a third value between the third threshold and a fourth threshold, wherein the third value is greater than the second value.

Statement 7: A method according to any of Statements 2 to 6, wherein the hash rate has a maximum value above a fifth threshold.

Statement 8: A method according to any of Statements 2 to 7, wherein the first threshold comprises a non-zero value.

Statement 9: A method according to any preceding Statement, wherein determining if a number of transactions in a set of validated transactions is above a first threshold comprises determining if an amount of transaction fees is above a threshold of transaction fees.

Statement 10: A method according to any preceding Statement, wherein the node is powered by rechargeable battery, and wherein the rechargeable battery is charged when the number of transactions in the set of validated transactions is below the first threshold.

Statement 11: A method according to any of Statements 2 to 10, wherein the node comprises a plurality application-specific-integrated-chips, wherein the plurality of application-specific-integrated-chips are turned on at different times to hash the set of validated transaction at the hash rate.

Statement 12: A method according to any preceding Statement, wherein when the number of transaction in the set of validated transactions is below the first threshold, the node is turned off to cool down.

Statement 13: A method according to any preceding Statement, wherein the computations comprise hashing data that is dependent on the set of validated transactions.

Statement 14: A method according to Statement 13, wherein the data comprises a block header.

The node of Statements 1 to 14 may comprise a hashing node.

Statement 15: An apparatus comprising at least one processor and at least one memory storing instructions that, when executed by the at least one processor, cause the apparatus at least to: determine if a number of transactions in a set of validated transactions is above a first threshold; when the number of transactions in the set of validated transactions is above the first threshold, hash the set of validated transactions.

Statement 16: Computer equipment comprising: memory comprising one or more memory units; and processing apparatus comprising one or more processing units, wherein the memory stores code arranged to run on the processing apparatus, the code being configured so as when on the processing apparatus to perform the method of any of Statements 1 to 14.

Statement 17: A computer program embodied on computer-readable storage and configured so as, when run on one or more processors, to perform the method of any of Statements 1 to 14.

1. A method performed by a node in a blockchain network, the method comprising:
determining if a number of transactions in a set of validated transactions is above a first threshold;
when the number of transactions in the set of validated transactions is above the first threshold, performing computations to include the set of validated transactions in a blockchain.

2. The method of claim 1, wherein performing computations to include the set of validated transactions in a blockchain comprises hashing of the set of validated transactions at a hash rate, the hash rate based on the number of transactions in the set of validated transactions.

3. The method of claim 2, wherein the hash rate increases linearly based on the number of transactions in the set of validated transactions.

4. The method of claim 2, wherein the hash rate increases non-linearly based on the number of transactions in the set of validated transactions.

5. The method of claim 2, wherein the hash rate has a first value between the first threshold and a second threshold, and wherein the hash rate has a second value between the second threshold and a third threshold, wherein the second value is greater than the first value.

6. The method of claim 5, wherein the hash rate has a third value between the third threshold and a fourth threshold, wherein the third value is greater than the second value.

7. The method of A method according to any of claim 2, wherein the hash rate has a maximum value above a fifth threshold.

8. The method of claim 1, wherein the first threshold comprises a non-zero value.

9. The method of claim 1, wherein determining if a number of transactions in the set of validated transactions is above a first threshold comprises determining if an amount of transaction fees is above a threshold of transaction fees.

10. The method of claim 1, wherein the node is powered by a rechargeable battery, and wherein the rechargeable battery is charged when the number of transactions in the set of validated transactions is below the first threshold.

11. The method of claim 2, wherein the node comprises a plurality of application-specific-integrated-chips, wherein the plurality of application-specific-integrated-chips are turned on at different times to hash the set of validated transaction at the hash rate.

12. The method of claim 1, wherein when the number of transactions in the set of validated transactions is below the first threshold, the node is turned off to cool down.

13. The method of claim 1, wherein the computations comprise hashing data that is dependent on the set of validated transactions.

14. The method of claim 13, wherein the data comprises a block header.

15. An apparatus, comprising:
at least one processor and at least one memory storing instructions that, when executed by the at least one processor, cause the apparatus at least to:
determine if a number of transactions in a set of validated transactions is above a first threshold;
when the number of transactions in the set of validated transactions is above the first threshold, perform computations to include the set of validated transactions in a blockchain.

16. Computer equipment, comprising:
memory comprising one or more memory units; and
processing apparatus comprising one or more processing units, wherein the memory stores code arranged to run on the processing apparatus, the code being configured so as when on the processing apparatus to perform a method performed by a node in a blockchain network, the method comprising:
determining if a number of transactions in a set of validated transactions is above a first threshold;
when the number of transactions in the set of validated transactions is above the first threshold, performing computations to include the set of validated transactions in a blockchain.

17. A computer program product embodied on non-transistory computer-readable storage media and configured so as, when run on one or more processors, the one or more processors perform a method performed by a node in a blockchain network, the method comprising:
determining if a number of transactions in a set of validated transactions is above a first threshold;
when the number of transactions in the set of validated transactions is above the first threshold, performing computations to include the set of validated transactions in a blockchain.
